(19) United States
(12) Patent Application Publication
(10) Pub. No.: US 2008/0276016 A1
(43) Pub. Date: Nov. 6, 2008

(54) STORAGE CONTROLLER AND STORAGE CONTROLLER CONTROL METHOD

(76) Inventor: Akira FUJIBAYASHI, Sagamihara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/968,776

(22) Filed: Jan. 3, 2008

(30) Foreign Application Priority Data
May 2, 2007 (JP) 2007-121379

(51) Int. Cl. G06F 3/00

(52) U.S. Cl. 710/36

(57) ABSTRACT

A storage controller of the present invention makes use of changes in power rates according to time periods, and controls the data storage destination between storage devices having different power consumption, such as a hard disk drive and a flash memory device. The storage controller comprises a hard disk drive and a flash memory device for which power consumption differs. A schedule manager manages a schedule for controlling the storage destination of data used by a host. Data is copied from the hard disk drive to the flash memory device at night, when the power rate is low. An access from a host is processed using data inside the flash memory device during the daytime when the power rate is high. The next night, the difference is copied so that the data of the flash memory device coincides with the data of the hard disk drive.

### CROSS-REFERENCE TO RELATED APPLICATIONS

This application relates to and claims priority from Japanese Patent Application No. 2007-121379 filed on May 2, 2007, the entire disclosure of which is incorporated herein by reference.

### BACKGROUND OF THE INVENTION

1. Field of the Invention

The present invention relates to a storage controller and a control method for a storage controller.

2. Description of the Related Art

For example, companies and other such organizations use storage controllers to manage large amounts of data. For example, organizations such as financial institutions and hospitals require highly reliable, large-capacity storage controllers due to their need to store transaction data and diagnostic data for large numbers of customers for long periods of time. A storage controller that fulfills the demand for both high reliability and large capacity, for example, comprises a large number of hard disk drives, and can provide a host with storage space based on RAID (Redundant Array of Independent Disks).

Data that must be managed for long periods of time is increasing on a daily basis at companies and the like. Therefore, the number of hard disk drives incorporated into storage controllers is also on the rise. As is well known, a hard disk drive carries out the reading and writing of data by causing a magnetic head to seek while a spindle motor rotates a magnetic disk at high speed. Thus, a hard disk drive consumes a larger amount of power than a storage device such as a semiconductor memory.

The larger the storage capacity of a storage controller, the greater the number of hard disk drives that is mounted in the storage controller. Therefore, the power consumption of the storage controller increases. As power consumption increases, the total cost of operation (TCO) of the storage controller also rises.

Thus, a technology called MAID (Massive Array of Idle Disks) reduces power consumption by setting unused hard disks to the standby mode. Further, technology for improving latency by shifting a standby hard disk to the spin-up mode as quickly as possible (Japanese Patent Laid-open No. 2007-79749) and technology for managing the amount of power consumed by a hard disk in accordance with logical volume operating results (Japanese Patent Laid-open No. 2007-79754) have also been proposed.

The above-mentioned prior art can reduce the amount of power consumed by a hard disk drive. However, even further reductions of power costs are required today. Thus, the flash memory device has gained attention in recent years as a new storage device. Compared to a hard disk drive, a flash memory device generally consumes less power, and reads out data faster.

However, due to the physical structure of its cells, a flash memory device is limited as to the number of writes it can perform. Further, since a charge stored in a cell diminishes over time, storing data over a long period requires the execution of refresh operations at regular intervals.

Since a storage controller is required to stably stored large amounts of data for a long period of time, it is difficult to use flash memory devices as-is. Even if both flash memory devices and hard disk drives could be mounted in a storage controller, it is impossible to reduce the amount of power consumed by the storage controller as a whole when accesses from a host computer focus on the hard disk drives.

### SUMMARY OF THE INVENTION

Accordingly, an object of the present invention is to provide a storage controller and a storage controller control method, which make it possible to switch the data storage destination between a first storage device and a second storage device based on a schedule that is configured by taking power costs into account. Another object of the present invention is to provide a storage controller and a storage controller control method, which make it possible to amend a data storage destination in accordance with the life of the first storage device. Yet further objects of the present invention should become clear from the descriptions of the embodiments explained below.

To solve for the above-mentioned problems, a storage controller, which accords with the present invention, and which stores data utilized by a higher-level device, comprises a first storage device, which comprises a nonvolatile, rewritable storage medium, and for power consumption is relatively low; a second storage device, which comprises a nonvolatile, rewritable storage medium, and for which power consumption is relatively high; a schedule manager for managing a schedule for controlling a prescribed data storage destination on a power cost basis; and a controller for respectively controlling the operations of the first storage device and the second storage device, and for switching a prescribed data storage destination between the first storage device and the second storage device based on the schedule.

In an embodiment of the present invention, the controller can use the first storage device to process an access request from a higher-level device.

In an embodiment of the present invention, the controller can control a prescribed data storage destination on the basis of the schedule such that the storage destination becomes the first storage device during a time period when the cost of power is relatively high, and becomes the second storage device during a time period when the cost of power is relatively low.

In an embodiment of the present invention, information showing a first period during which the higher-level device accesses prescribed data can also be recorded in the schedule.

An embodiment of the present invention further comprises an access status manager for detecting and managing the state in which a higher-level device accesses prescribed data, and can use the access status manager to create a schedule.

In one embodiment of the present invention, a condition set in advance by a user, who utilizes the prescribed data, can also be recorded in the schedule.

In an embodiment of the present invention, the controller can copy in advance at least a portion of the prescribed data from the second storage device to the first storage device prior to the arrival of the first period, and can copy the difference between the contents of the first storage device and the contents of the second storage device from the first storage device to the second storage device following the end of the first period.

In an embodiment of the present invention, the controller can store write data received from the higher-level device in the first storage device when the free space of the first storage device is not less than a prescribed value, and can store the write data in the second storage device when the free space of the first storage device is less than the prescribed value.

An embodiment of the present invention further comprises a cache memory, and the controller can also (1) store write data received from a higher-level device in the first storage device when the free space of the first storage device is not less than a prescribed value, (2) store the write data in the cache memory when the free space of the first storage device is less than the prescribed value, and the free space of the cache memory is not less than another prescribed value, and (3) store the write data in the second storage device when the free space of the first storage device is less than the prescribed value, and the free space of the cache memory is less than the other prescribed value.

In an embodiment of the present invention, information showing the first period in which a higher-level device accesses prescribed data, and one condition of either a first condition or a second condition set by a user, who utilizes the prescribed data, are respectively set in the schedule, and the controller can (1) commence copying prescribed data from the second storage device to the first storage device prior to the arrival of the first period, and (1a) when the first condition has been set, end copying upon transitioning from a time period when the cost of power is relatively low to a time when the cost of power is relatively high, and (1b) when the second condition has been configured, copy all of the prescribed data from the second storage device to the first storage device even after transitioning to a time period when the cost of power is relatively high.

In an embodiment of the present invention, the controller transitions the second storage device to a power saving mode when the storage destination of the prescribed data has been changed from the second storage device to the first storage device.

In an embodiment of the present invention, the controller predicts the life of the first storage device based on the utilization status of the first storage device, and when the predicted life reaches a prescribed threshold, changes the prescribed data storage destination to either the second storage device, or a different first storage device.

In an embodiment of the present invention, the controller predicts the life of the first storage device based on the utilization status of the first storage device, and when the predicted life reaches a prescribed threshold, and a percentage of read requests related to the first storage device is less than a preset determination threshold, changes the prescribed data storage destination to either the second storage device, or a different first storage device.

In an embodiment of the present invention, the controller predicts the life of the first storage device based on the utilization status of the first storage device, and (1) when the predicted life reaches a prescribed threshold, (1a) changes the prescribed data storage destination to the second storage device when a percentage of read requests related to the first storage device is less than the preset determination threshold, (1b) changes the prescribed data storage destination to a different first storage device when the percentage of read requests related to the first storage device is not less than the preset determination threshold, and furthermore, (2) changes the prescribed data storage destination to the second storage device when the percentage of read requests related to the first storage device is less than the determination threshold even though the predicted life has not reached the prescribed threshold.

In an embodiment of the present invention, the first storage device is a flash memory device, and the second storage device is a hard disk device.

A method, which accords with another aspect of the present invention, and which is for controlling a storage controller for storing data used by a higher-level device, and the storage controller can respectively make use of a first device with relatively low power consumption, and a second storage device with relatively high power consumption, and the storage controller control method comprises a step for commencing the copying of prescribed data from the second storage device to the first storage device during a second period prior to the arrival of the first period in which the higher-level device accesses the prescribed data; a step for using the first storage device to process an access request from the higher-level device; a step for detecting a difference, which occurs between the first storage device and the second storage device resulting from the access request; and a step for copying the difference from the first storage device to the second storage device during a different second period of subsequent to the end of the first period, and the first period is set at a time when power costs are relatively high, and the second period is set at a time when power costs are relatively low.

Either all or a portion of the components of the present invention can be constituted as a computer program. This computer program can be transferred by being put on a recording medium, or it can also be transmitted via the Internet or some other such communication network.

### BRIEF DESCRIPTION OF THE DRAWINGS

FIG. 1 is a schematic diagram showing a concept of an embodiment of the present invention;

FIG. 2 is a schematic diagram showing the overall constitution of a storage system comprising a storage controller;

FIG. 3 is a schematic view showing an example of storage controller utilization;

FIG. 4 is a schematic diagram showing the constitution of a channel adapter;

FIG. 5 is a schematic diagram showing the constitution of a flash memory controller;

FIG. 6 is a schematic diagram showing a mapping table;

FIG. 7 is a schematic diagram showing a configuration management table and a device status management table;

FIG. 8 is a schematic diagram showing an access history management table and a schedule management table;

FIG. 9 is a diagram schematically showing the relationship between changes in power rates and changes in the data storage destination;

FIG. 10 is a flowchart showing a schedule creation process;

FIG. 11 is a flowchart showing a process for copying data in advance from a disk drive to a flash memory device;

FIG. 12 is a flowchart showing a write process;

FIG. 13 is a flowchart showing a difference copy process;

FIG. 14 is a flowchart showing a read process;

FIG. 15 is a flowchart showing a process for determining a data storage destination;

FIG. 16 is a flowchart of write processing executed by a storage controller of a second embodiment;

FIG. 17 is a flowchart of write processing executed by a storage controller of a third embodiment;

FIG. 18 is a schematic diagram showing the constitution of a flash memory controller used in a storage controller of a fourth embodiment;

FIG. 19 is a schematic diagram showing the constitution of a flash memory controller used in a storage controller of a fifth embodiment;

FIG. 20 is a schematic diagram showing a management table used by a storage controller of a sixth embodiment;

FIG. 21 is a flowchart of write processing executed by a storage controller of the sixth embodiment; and

FIG. 22 is a flowchart showing a process for copying data in advance from the disk drive to a flash memory device executed by a storage controller of a seventh embodiment.

### DESCRIPTION OF THE PREFERRED EMBODIMENTS

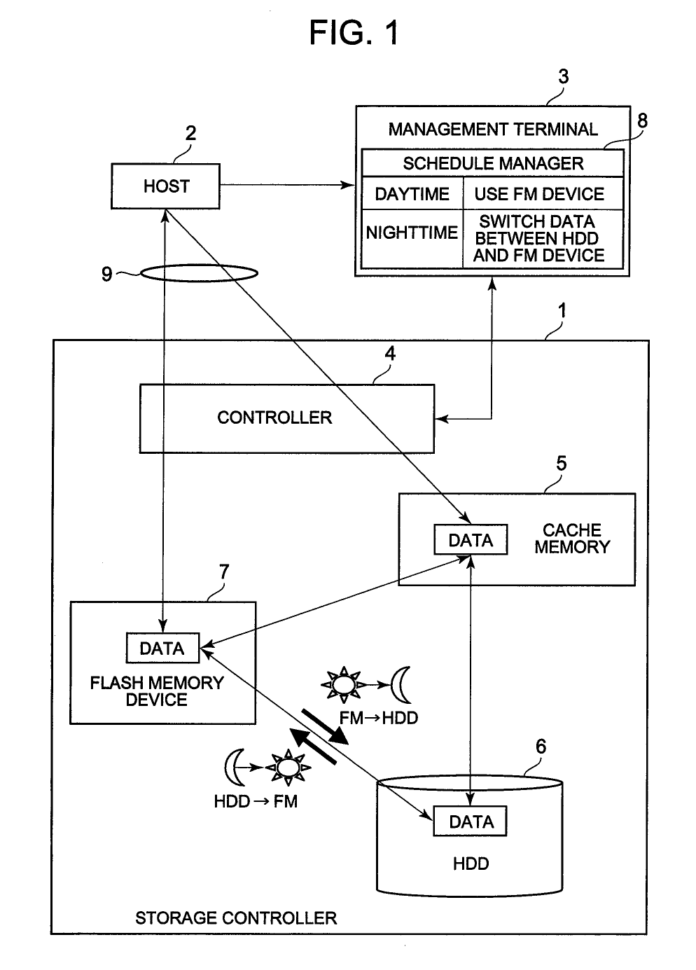

The embodiments of the present invention will be explained below by referring to the figures. FIG. 1 is a schematic diagram showing an overall concept of this embodiment. The storage system shown in FIG. 1, for example, is constituted comprising a storage controller 1, a host computer (hereinafter, host) 2 as a “higher-level device”, and a management terminal 3.

The storage controller 1, for example, comprises a controller 4, cache memory 5, hard disk drive 6, and flash memory device 7. The controller 4 processes an access request from a host 2. Further, the controller 4 controls the exchange of data between the cache memory 5, hard disk drive 6 and flash memory device 7, respectively.

The cache memory 5, for example, comprises a volatile semiconductor memory, and temporarily stores write data received from the host 2, as well as read data for transmission to the host 2.

The hard disk drive 6 is equivalent to the “second storage device”. As the hard disk drive 6, for example, a FC (Fibre Channel) disk, SCSI (Small Computer System Interface) disk, SATA disk, ATA (AT Attachment) disk, SAS (Serial Attached SCSI) disk and the like can be used. The hard disk drive 6 of this embodiment is used for the long-term stable storage of large amounts of data utilized by the host 2.

The flash memory device 7 is equivalent to the “first storage device”. In this embodiment, basically, memory elements for storing data are called a flash memory, and a device comprising a flash memory and various types of mechanisms is called a flash memory device. The various types of mechanisms can include, for example, a protocol processor and a wear-leveling adjustor. Wear-leveling adjustment is a function for adjusting the number of writes to respective cells so that each cell receives an equal number. Either a NAND-type or a NOR-type flash memory device can be used as the flash memory device 7 as deemed appropriate.

The host 2, for example, is constituted as a computer device, such as a server computer, mainframe computer, workstation, personal computer, or a mobile computing device (to include a mobile telephone). The host 2 and the storage controller 1, for example, are connected via a communication network 9, such as a SAN (Storage Area Network). The host 2 and the storage controller 1, for example, carry out two-way communications in accordance with a fibre channel protocol or an iSCSI (internet Small Computer System Interface) protocol. The host 2, for example, comprises an application program, such as a database program, and the application program uses data stored in the storage controller 1.

The management terminal 3 can be called a “management device”. The management terminal 3, for example, can be constituted as computer device, such as a server computer, personal computer, or mobile computing device. The management terminal 3 can acquire the internal status of the storage controller 1, and can change the configuration of the storage controller 1 by carrying out communications with the controller 4.

The management terminal 3 of this embodiment further comprises a schedule manager 8. The schedule manager 8 primarily manages a schedule for determining a data storage destination from among the hard disk drive 6 and the flash memory device 7. The controller 4 controls the data storage destination in accordance with a preset schedule. For example, the schedule is configured such that at night, when the cost of power is low, data is copied in advance from the hard disk drive 6 to the flash memory device 7, and during the day, which the cost of power is high, an access request from the host 2 is processed using the flash memory device 7.

Furthermore, in FIG. 1, the schedule manager 8 is shown as being provided inside the management terminal 3, but the present invention is not limited to this, and, for example, the constitution can be such that the schedule manager 8 is provided inside the host 2 or the storage controller 1.

The operation of this embodiment will be explained. The controller 4 copies prescribed data stored in the hard disk drive 6 to the flash memory device 7 during the night based on the schedule. The prescribed data, for example, is data, which has a high likelihood of being used by the host 2. For example, as will become clear from the embodiments explained further below, which host will use what data at what time can be predicted by monitoring and creating a history of the host's 2 utilization of the storage controller 1.

Prescribed data that is expected to be utilized during the day is copied from the hard disk drive 6 to the flash memory device 7 during the night. The host 2 can either read out a portion or all of the prescribed data copied to the flash memory device 7, or the host 2 can update either a portion or all of the prescribed data copied to the flash memory device 7.

That is, in this embodiment, the high-power-consumption hard disk drive 6 can be operated at night, when the power rate is low, to copy prescribed data to the flash memory device 7. Then, the low-power-consumption flash memory device 7 can be used to process an access request from the host 2 during the day, when the power rate is high. Therefore, it is possible to cut down on the power consumption of the storage controller 1 as a whole, thereby lowering power costs.

In other words, in this embodiment, the flash memory device 7 can be used like a cache memory, the staging process for copying data from the hard disk drive 6 to the flash memory device 7 is executed at night when the power rate is low. Then, the destaging process for copying data from the flash memory device 7 to the hard disk drive 6 is also executed at night, when the power rate is low.

Furthermore, in this embodiment, the cache memory 5 can also be used to prevent as much as possible the operation of the hard disk drive 6 during the daytime, when the power rate is high. For example, when the free space of the flash memory device 7 is insufficient, either all or a portion of the data, which is to be written to the flash memory device 7, can be written to the cache memory 5.

When the transition is made from the day time period, when the power rate is high, to the night time period, when the power rate is low, the controller 4 copies the prescribed data inside the flash memory device 7 to the hard disk drive 6. The method for copying the prescribed data from the flash memory device 7 to the hard disk drive 6 can use either a total copy or a difference copy.

A total copy is a method for transferring and copying all of the data in the flash memory device 7 to the hard disk drive 6. A difference copy is a method for transferring and copying only the data that differs between the flash memory device 7 and the hard disk drive 6 from the flash memory device 7 to the hard disk drive 6. When using a total copy, it takes time until copying ends, but copy control is simple. When using a difference copy, copying can be completed in a relatively short time, but a scheme for managing the differences between the flash memory device 7 and the hard disk drive 6 is required. This embodiment will be explained in detail hereinbelow.

### First Embodiment

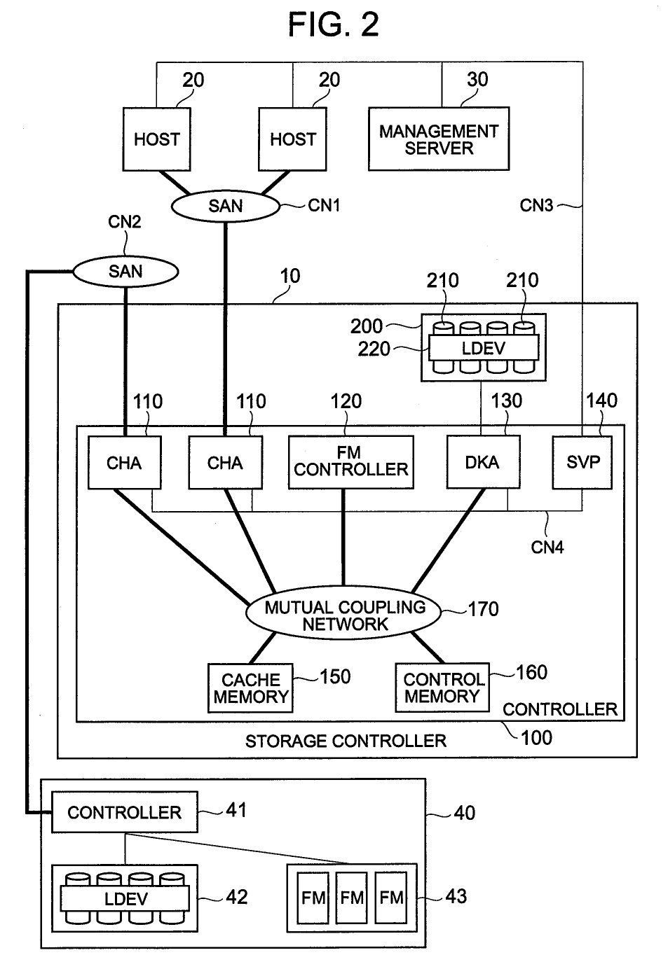

FIG. 2 is a schematic diagram showing the overall constitution of a storage system comprising a storage controller 10 according to this embodiment. This storage system, for example, comprises either one or a plurality of storage controllers 10, either one or a plurality of hosts 20, and at least one management server 30. The storage system can also comprise a separate storage controller 40. The storage controller 10 corresponds to the storage controller 1 of FIG. 1. The host 20 corresponds to the host 2 of FIG. 1. The management server 30 corresponds to the management terminal 3 of FIG. 1. Details concerning the storage controller 10, host 20, management server 30 and external storage controller 40, will be respectively explained hereinbelow.

The storage system's network configuration will be explained by referring to FIG. 2. The respective hosts 20 and storage controller 10, for example, are intercommunicably connected via a communication network CN 1 such as a SAN. This can be an IP_SAN, which uses the IP (Internet Protocol), or it can be a FC_SAN, which uses the FCP (Fibre Channel Protocol).

The management server 30, for example, is intercommunicably connected to the respective hosts 20 and the storage controller 10 via a communication network CN 3 for management purposes, such as a LAN (Local Area Network). Furthermore, when the storage system comprises an external storage controller 40, the management server 30 and the external storage controller 40 can also be intercommunicably connected via the communication network CN 3.

Furthermore, in FIG. 2, the data input/output network CN 1 and management network CN 3 are shown as being separate, but the present invention is not limited to this, and the constitution can also be such that data input/output and management are carried out using a single communication network. For example, the constitution can be such that the management network CN 3 is discarded, and only the communication network CN 1 is provided.

The external storage controller 40 is called an external storage controller in this embodiment because it is a separate storage controller, which exists externally of the storage controller 10. The external storage controller 40 is connected to the storage controller 10 via a communication network CN 2 for external connection purposes such as SAN. Furthermore, the constitution can be such that the external connection communication network CN 2 is discarded, and the storage controller 10 and external storage controller 40 are connected by the data input/output network CN 1.

The constitution of the storage controller 10 will be explained. The storage controller 10, for example, comprises a controller 100 and a hard disk carrier 200. The controller 100 comprises at least one or more channel adapters (hereinafter, CHA) 110, at least one or more flash memory device controllers (hereinafter FM controller) 120, at least one or more disk adapters (hereinafter, DKA) 130, a service processor (hereinafter, SVP) 140, a cache memory 150, a control memory 160, and an mutual coupling network 170. Furthermore, a plurality of CHAs 110, FM controllers 120, and DKAs 130 are respectively provided inside the controller 100.

A CHA 110 is for controlling data communications with a host 20, and, for example, is constituted as a computer device comprising a microprocessor and a local memory. The respective CHAs 110 comprise at least one or more communication boards. For example, identification information, such as WWN (World Wide Name), is configured in the communication board. When the host 20 and the storage controller 10 carry out data communications using an iSCSI (internet Small Computer System Interface), identification information, such as an IP (Internet Protocol) address, is configured in the communication board.

Two types of CHA 110 are shown in FIG. 2. The one CHA 110, which is located on the right side of FIG. 2, is for receiving and processing a command from the host 20, and its communication board becomes the target board. The CHA 110, which is located on the left side of FIG. 2, is for executing a command to the external storage controller 40, and its communication board becomes the initiator board.

The DKA 130 is for controlling data communications with the respective disk drives 210, and the same as the CHA 110, is constituted as a computer device comprising a microprocessor and a local memory.

The DKA 130 and the respective disk drives 210, for example, are connected via a communication channel that conforms to the Fibre Channel Protocol. The DKA 130 and respective disk drives 210 carry out data transfers in block units. The channel for the controller 100 to access the respective disk drives 210 is redundant. If a failure occurs in the DKA 130 or communication channel of either one side, the controller 100 can access a disk drive 210 using the DKA 130 and communication channel of the other side. Similarly, the channel between the host 20 and controller 100, and the channel between the external storage controller 40 and the controller 100 can be made redundant. Furthermore, the DKA 130 constantly monitors the status of the disk drives 210. The SVP 140 acquires the results of monitoring by the DKA 130 via an internal network CN 4.

The operations of the CHA 110 and DKA 130 will be explained briefly. The CHA 110, upon receiving a read command issued from the host 20, stores this read command in the control memory 160. The DKA 130 constantly references the control memory 160, and upon detecting an unprocessed read command, reads out data from the disk drive 210, and stores it in the cache memory 150. The CHA 110 reads the data, which was migrated to the cache memory 150, and sends same to the host 20.

Conversely, upon receiving a write command issued from the host 20, the CHA 110 stores this write command in the control memory 160. Further, the CHA 110 stores the received write data in the cache memory 150. The CHA 110, upon storing the write command in the cache memory 150, reports write-end to the host 20. The DKA 130 reads out data stored in the cache memory 150 in accordance with the write command stored in the control memory 160, and stores same in a prescribed disk drive 210.

However, the above explanation is an example of a situation in which an access request from the host 20 is processed using a disk drive 210. As will be explained hereinbelow, in this embodiment, an access request from a host 20 is processed primarily by using the FM controller 120. When there is insufficient free space in the flash memory, or when storing data stored in the flash memory to a disk drive 210, the DKA 130 writes the data to the disk drive 210.

The FM controller 120 corresponds to the flash memory device as the “first storage device”. The constitution of the FM controller 120 will be explained further hereinbelow, but the FM controller 120 is equipped internally with a plurality of flash memories. The FM controller 120 of this embodiment is provided inside the controller 100. In an embodiment explained hereinbelow, a flash memory device is provided externally of the controller 100. Furthermore, in this embodiment, the flash memory device is cited as an example of the first storage device, but the present invention is not limited to this, and a storage device, which is rewritable, nonvolatile, and consumes less power than the second storage device can be used in the present invention.

The SVP 140 is communicably connected to the CHA 110, FM controller 120 and DKA 130 via an internal network CN 4 such as a LAN (Local Area Network). Further, the SVP 140 is connected to the management server 30 via a communication network CN 3, such as a LAN or the Internet. The SVP 140 acquires the various states inside the storage controller 10, and provides same to the management server 30. Furthermore, the SVP 140 can also be connected to only one of either a CHA 110 or DKA 130. This is because the SVP 140 can acquire a variety of status information via the control memory 160.

The cache memory 150, for example, is for storing data and so forth received from a host 20. The cache memory 150, for example, is constituted from a volatile memory. The control memory 160, for example, is constituted from a nonvolatile memory. For example, a variety of management information, which will be described hereinbelow, is stored in the control memory 160.

The control memory 160 and the cache memory 150 can be respectively constituted as separate memory boards, or these memories can be mixedly provided on the same memory board. Or, one portion of memory can be used as a cache area, and another portion used as a control area.

The mutual coupling network 170 mutually connects the respective CHA 110, FM controller 120, and DKA 130, to the cache memory 150 and control memory 160. Consequently, all CHAs 110 and the DKA 130 are capable of accessing the FM controller 120, cache memory 150 and control memory 160. The mutual coupling network 170, for example, can be constituted as a crossbar switch.

The constitution of the controller 100 is not limited to the constitution described hereinabove. For example, the constitution can be such that a function for respectively carrying out data communications between a host 20 and the external storage controller 40, a function for carrying out data communications with the flash memory device, a function for carrying out data communications with a disk drive 210, and a function for temporarily storing data are respectively provided on either one or a plurality of control boards. The external dimensions of the storage controller 10 can be made smaller by using a controller board like this.

The constitution of the hard disk carrier 200 will be explained. The hard disk carrier 200 comprises a plurality of disk drives 210. The respective disk drives 210 are equivalent to the “second storage device.” For example, FC disks, SATA disks and a variety of other such hard disk drives can be used as disk drives 210.

Differences will occur by RAID configuration, and, for example, a parity group is constituted from a prescribed number of disk drives 210 of three per group, four per group, and so forth. A parity group is for virtualizing the physical storage areas of the respective disk drives 210 inside the parity group. The parity group is a virtualized physical storage device.

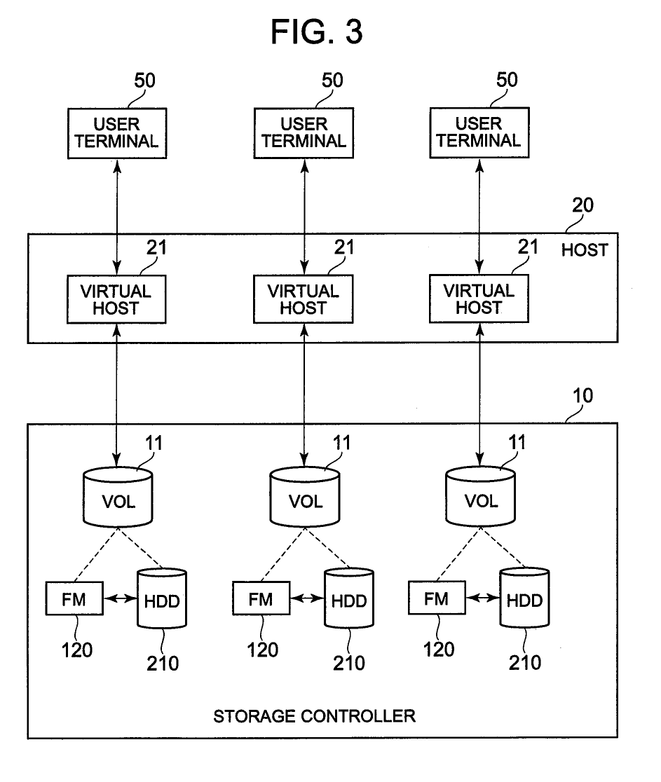

Either one or a plurality of logical devices (LDEV: Logical DEVice) 220 of either a prescribed size or a variable size can be set in the physical storage area of the parity group. The logical device 220 is a logical storage device, and corresponds to a logical volume 11 (Refer to FIG. 3).

The external storage controller 40, for example, can comprise a controller 41, hard disk carrier 42, and flash memory device carrier 43 the same as the storage controller 10. The controller 41 can create a logical volume by using a disk drive storage area and a flash memory device storage area.

The external storage controller 40 is called an external storage controller because it resides outside the storage controller 10 as seen from the storage controller 10. Further, a disk drive of the external storage controller 40 may be called an external disk, a flash memory device of the external storage controller 40 may be called an external flash drive device, and a logical volume of the external storage controller 40 may be called an external volume, respectively.

For example, a logical volume inside the external storage controller 40 is correspondent to a virtual logical device (VDEV: Virtual DEVice) provided inside the storage controller 10 via the communication network CN 2. A virtual logical volume can be configured on the storage space of the virtual logical device. Therefore, the storage controller 10 can make a logical volume (external volume) inside the external storage controller 40 appear to a host 20 as a logical volume inside the storage controller 10.

When an access request is issued to a virtual logical volume, the storage controller 10 converts the command of the access request for the virtual logical volume to a command for accessing a logical volume inside the external storage controller 40. The converted command is sent from the storage controller 10 to the external storage controller 40 via communication network CN 2. The external storage controller 40 carries out data reading and writing in accordance with the command received from the storage controller 10, and returns the results to the storage controller 10.

Thus, the storage controller 10 can use a storage resource (logical volume) inside a separate storage controller 40, which exists externally, as if it is a storage resource inside the storage controller 10. Therefore, the storage controller 10 does not always have to comprise a disk drive 210 and DKA 130. This is because it is able to use a storage resource provided by a hard disk inside the external storage controller 40. The storage controller 10 can also be constituted as a high-functionality fibre channel switch equipped with a flash memory device.

FIG. 3 is a schematic diagram showing an example of one method of using the storage controller 10. FIG. 2 shows an example of when a plurality of hosts 20, which are constituted as respective individual computer devices, access the storage controller 10 to read and write data.

By contrast, a plurality of virtual hosts 21 can also be provided inside a single host 20 as shown in FIG. 3, and these virtual hosts 21 can read and write data by accessing a logical volume 11 inside the storage controller 10.

A plurality of virtual hosts 21 can be created by virtually partitioning the computer resources (CPU execution time, memory and so forth) of a single host 20. A user terminal 50, which is utilized by a user, accesses a virtual host 21 via a communication network, and uses the virtual host 21 to access its own dedicated logical volume 11 configured inside the storage controller 10. The user terminal 50 can comprise the minimum functions required for using the virtual host 21.

A logical volume 11, which is correspondent to a disk drive 210 and a flash memory device 120 (hereinafter, an FM controller 120 may be called a flash memory device), is provided inside the storage controller 10. The respective user terminals 50 access the respective user logical volumes 11 via a virtual host 21. Providing a plurality of virtual hosts 21 inside a host 20 makes it possible to effectively utilize computer resources.

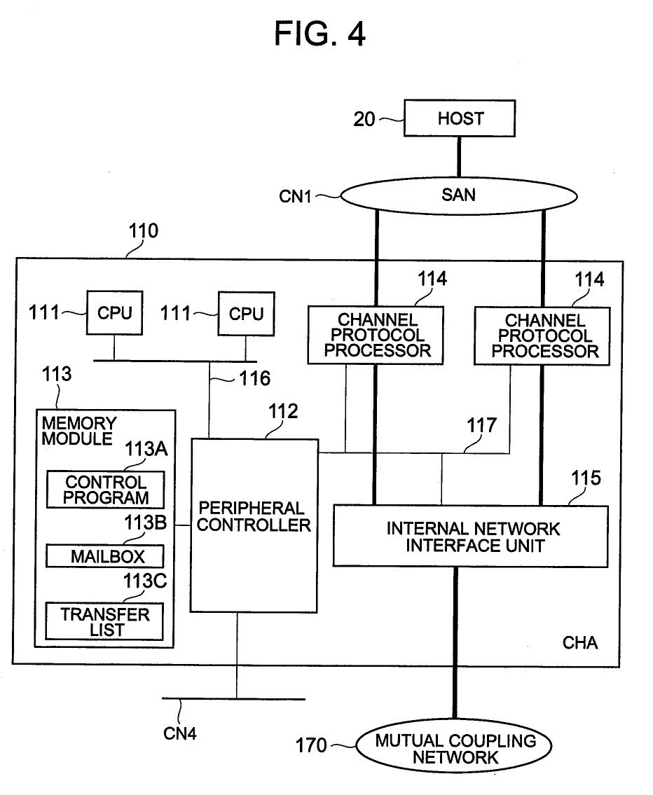

FIG. 4 is a schematic diagram showing the constitution of a CHA 110. The CHA 110, for example, comprises a plurality of microprocessors (CPU) 111; a peripheral processor 112; a memory module 113; a channel protocol processor 114; and an internal network interface unit 115.

The respective microprocessors 111 are connected to the peripheral processor 112 via a bus 116. The peripheral processor 112 is connected to the memory module 113, and controls the operation of the memory module 113. Furthermore, the peripheral processor 112 is connected via a bus 117 to the respective channel protocol processors 114. The peripheral processor 112 processes packets respectively inputted from the respective microprocessors 111, respective channel protocol processors 114 and internal network interface unit 115. For example, in the case of a packet for which the transfer destination is the memory module 113, the peripheral processor 112 processes this packet, and, if necessary, returns the processing results to the packet source. The internal network interface unit 115 is a circuit for communicating with other CHA 110, the FM controller 120 (flash memory device 120), DKA 130, cache memory 150 and control memory 160 via the mutual coupling network 170.

Inside the memory module 113, for example, there are provided a control program 113A, a mailbox 113B, and a transfer list 113C. The respective microprocessors 111 read out and execute the control program 113A. The respective microprocessors 111 carry out communications with the other microprocessor 111 via the mailbox 113B. The transfer list 113C is a list for the channel protocol processor 114 to carry out DMA (Direct Memory Access).

The channel protocol processor 114 executes processing for carrying out communication with a host 20. The channel protocol processor 114, upon receiving an access request from a host 20, notifies the microprocessor 111 of a number and LUN (Logical Unit Number) for identifying this host 20, and the access destination address.

The microprocessor 111 prepares the transfer list 113C for sending data, which is considered the target of a read request, to the host 20 based on the contents communicated from the channel protocol processor 114. The channel protocol processor 114 reads out the data from either of the cache memory 150 or flash memory device 120 based on the transfer list 113C and sends same to the host 20. In the case of a write request, the microprocessor 111 sets the storage destination address of the write data in the transfer list 113C. The channel protocol processor 114 transfers the write data to either the flash memory device 120 or cache memory 150 on the basis of the transfer list 113C.

Furthermore, although the DKA 130 is substantially constituted the same as the CHA 110, the contents of the control program 113A differ.

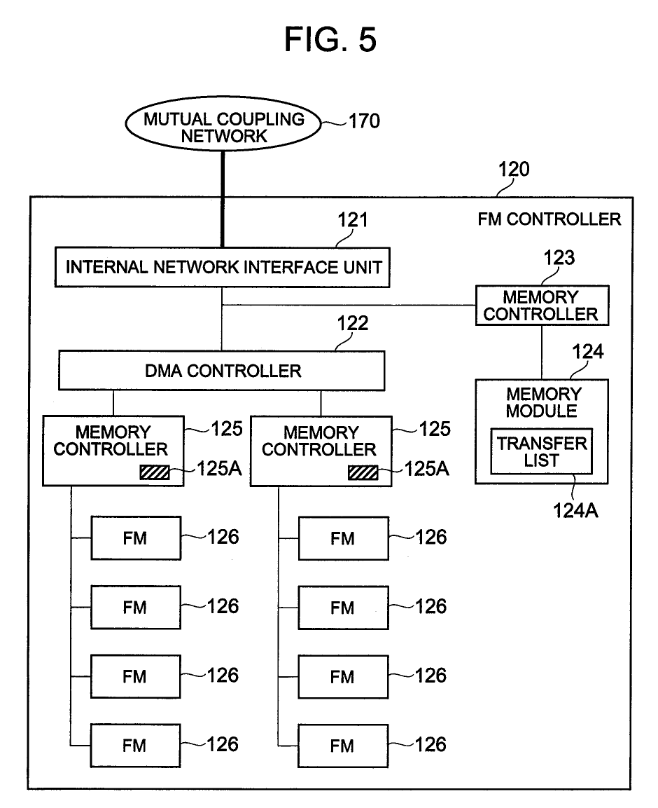

FIG. 5 is a schematic diagram showing the constitution of the FM controller 120. The FM controller 120, for example, comprises an internal network interface unit 121; a DMA controller 122; a memory controller 123; a memory module 124; a memory controller for a flash memory 125; and a flash memory 126.

The internal network interface unit 121 is a circuit for communicating with the CHA 110, DKA 130, cache memory 150 and control memory 160 via the mutual coupling network 170.

The DMA controller 122 is a circuit for carrying out a DMA transfer. The memory controller 123 is for controlling the operation of the memory module 124. The memory module 124 stores a transfer list 124A.

The memory controller for a flash memory 125 is a circuit for controlling the operation of a plurality of flash memories 126. A flash memory 126 is constituted as either a NAND- or NOR-type flash memory. The memory controller for a flash memory 125 is provided with a memory 125A for storing information on the number of accesses and deletions for the respective flash memories 126.

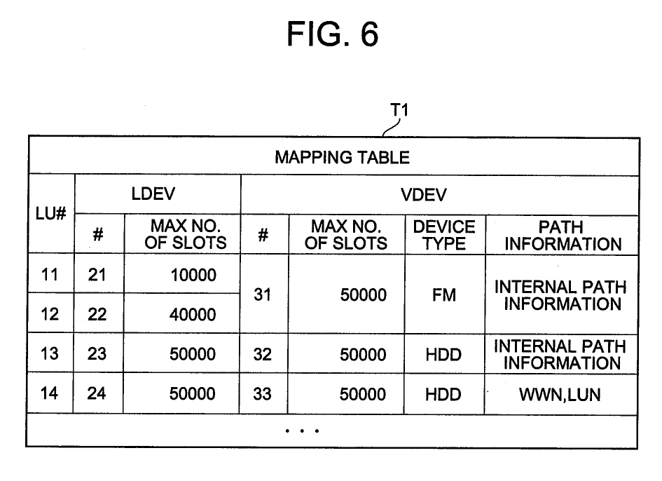

FIG. 6 is a schematic diagram showing an example of a mapping table T1. The mapping table T1 is used for the storage controller 10 to utilize a logical volume (that is, ultimately, a disk drive) inside the other storage controller 40. This table T1, for example, is stored inside the control memory 160.

The mapping table T1, for example, can be configured by making a LUN, a number for identifying a logical device (LDEV), and a number for identifying a virtual intermediate device (VDEV) correspond to one another.

Information for identifying a virtual intermediate device, for example, can comprise the number of the virtual intermediate device, information showing the type of physical storage device to which the virtual intermediate device is connected, and routing information for connecting to the physical storage device. When a virtual intermediate device has been made correspondent to either a flash memory device 120 or disk drive 210 inside the storage controller 10, internal path information for accessing the flash memory device 120 or disk drive 210 is configured.

When the virtual intermediate device is connected to a logical volume inside the external storage controller 40, the external path information, for example, comprises a WWN or LUN. The controller 100 of the storage controller 10 converts a command received from a host 20 to a command to be sent to the external storage controller 40 by referring to the mapping table T1.

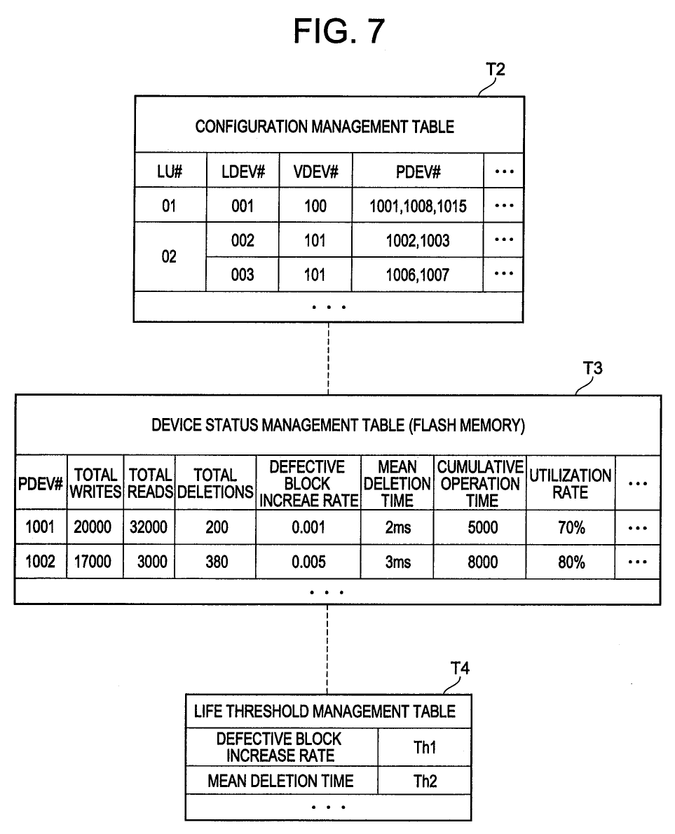

FIG. 7 is a schematic diagram respectively showing examples of the configurations of a configuration management table T2, a device status management table T3 and a life threshold management table T4.

The configuration management table T2 is for managing the configuration of a logical volume under the management of the storage controller 10. The configuration management table T2, for example, manages a number (LU#) for identifying a logical volume; a number (LDEV#) for identifying the logical device, which is correspondent to this logical volume; a number (VDEV#) for identifying the virtual intermediate device, which is correspondent to this logical device; and a number (PDEV#) for identifying the physical device, which is correspondent to this virtual intermediate device.

Furthermore, an LU, LDEV and VDEV are basically mapped onto a PDEV constituted from a disk drive 210. However, the constitution can also be such that the LU, LDEV and VDEV are mapped onto the flash memory device 120.

The disk status management table T3 is a table for managing the status of a physical storage device. FIG. 7 shows a table for managing the status of a flash memory device as the physical storage device.

Table T3, which manages the status of the flash memory device, for example, correspondingly manages a number (PDEV#) for identifying this flash memory device, the total number of times that data was written to this flash memory device, the total number of times that data was read from this flash memory device, the total number of times that data was deleted from this flash memory device, the rate of increase of defective blocks generated in this flash memory device, the mean time required for deleting data stored in this flash memory device, the cumulative operation time of this flash memory device, and the utilization rate (utilization rate=amount of stored data/flash memory storage capacity) of this flash memory device.

Due to the physical constitution of the cells, an upper limit may be set on the number of times write can be carried out for a flash memory. Therefore, managing the cumulative value of the number of writes (total number of writes) makes it possible to predict the remaining life of this flash memory device. Similarly, it is possible to predict the dwindling of remaining life from a rise in the value of the rate of increase of defective blocks in the flash memory device, and the extent to which the mean deletion time and total operating time lengthen.

The respective life prediction parameters mentioned above are examples, and the present invention is not limited to these. Furthermore, a life prediction parameter for enabling the level of reliability of the flash memory device to be taken into account in predicting the remaining life could also be called a parameter for determining reliability.

The life threshold management table T4 is a table, which manages a life threshold for detecting a decrease in the remaining life of the flash memory device. The life threshold management table T4 is pre-configured with life thresholds Th1, Th2, . . . , for each of the above-mentioned life prediction parameters (total number of writes, defective block increase rate, mean deletion time, and so forth).

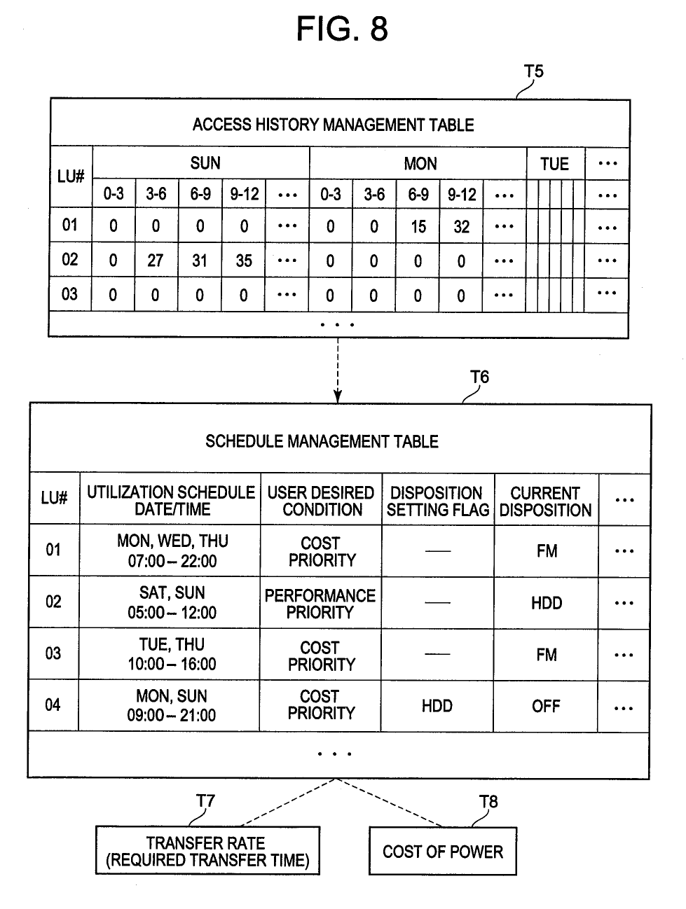

FIG. 8 is a schematic diagram showing examples of the configurations of an access history management table T5 and a schedule management table T6. The access history management table T5 is a table for managing the history of accesses for each respective logical volume. For example, the access history management table T5 can respectively manage the number of accesses to the respective logical volumes for the respective time periods of the respective days. FIG. 8 does not make a distinction between a write access and a read access, but in actuality, the number of accesses is detected and recorded at each time period of each day for write accesses and read accesses, respectively. The constitution can also be such that the amount of data per access (number of logical blocks) is combinedly recorded in the table T4.

The schedule management table T6 is for managing the utilization schedule of the respective logical volumes. The schedule management table T6 correspondently manages the utilization schedule date/time, user desired condition, disposition setting flag, and current disposition for each logical volume.

The “utilization schedule date/time” is information showing the date and times that a user is scheduled to use a logical volume, and can be automatically configured based on the access history recorded in the access history management table T5. A user can also manually correct an automatically configured utilization schedule date/time.

The “user desired condition” is information showing the condition desired when the user utilizes the logical volume, and, for example, either of “cost priority” or “performance priority” can be set. Cost priority is a mode in which precedence is given to reducing power costs. When the cost priority mode is selected, a logical volume data storage destination is controlled so that the total amount of power consumed while utilizing this logical volume is reduced as much as possible. Performance priority is a mode in which precedence is given to maintaining access performance. When the performance priority mode is selected, a logical volume data storage destination is controlled so that response performance drops as little as possible while utilizing this logical volume.

In this embodiment, as will be explained hereinbelow, at least a portion of the data inside a logical volume is copied beforehand from a disk drive 210 (including disk drives inside the external storage controller 40 as well) to the flash memory device utilizing the night time period, during which the power rate is low, in preparation for use by a user the following day. Consequently, an access request from a host 20 during the daytime, when the power rate is high, can be processed using the low-power-consumption flash memory device.

When a small amount of data is to be copied from a disk drive 210 to the flash memory device, all the data targeted for copying can be copied from the disk drive 210 to the flash memory device during the night, when the power rate is low. However, the storage controller 10 manages data used by large numbers of users, and the amount of data used by the respective users keeps increasing.

Therefore, consideration is given to situations in which all the data targeted for copying cannot be completely copied during the time period when the power rate is low. In this case, if emphasis is placed on power costs, it is better to end copying partway through, and stop the operation of the disk drive 210. This is because operating the disk drive 210, which is the copy source device, during the time period when the power rate is high, increases the cost of power for this logical volume.

By contrast, if emphasis is placed on access performance over power costs, it is better to continue copying from the disk drive 210 to the flash memory device even after transitioning to a high-power-rate time period in order to store all the data targeted for copying in the flash memory device. This is because the flash memory device generally surpasses the disk drive 210 in terms of data reading and writing speeds.

The “disposition setting flag” is information for establishing a logical volume data storage destination. When “HDD” is set in the disposition setting flag, the storage destination for this data is put on a disk drive 210. Therefore, data for which “HDD” is set is not copied from a disk drive 210 to the flash memory device.

The “current disposition” is information for specifying the storage device in which the logical volume data is stored. When “FM” is set in the current disposition, this data is stored in the flash memory device. When “HDD” is set in the current disposition, this data is stored in a disk drive 210. Disposition information can comprise not only the type of storage device, but also identification information (PDEV#) for specifying the storage device.

At the bottom of FIG. 8, a transfer rate management table T7 and a power cost management table T8 are also shown. The transfer rate management table T7 manages the data transfer rate between a disk drive 210 and the flash memory device. Therefore, the time required to complete data copying can be determined by multiplying the size of the copy-target data by the data transfer rate.

The power cost management table T8 stores information related to the cost of power supplied to the storage controller 10. For example, information related to power rates and the dates and times of power cost switchovers are stored in the table T8. When the power company responsible for the region in which the storage controller 10 and external storage controller 40 are installed publicizes power cost-related information over a communication network, the power cost management table T8 can be created automatically.

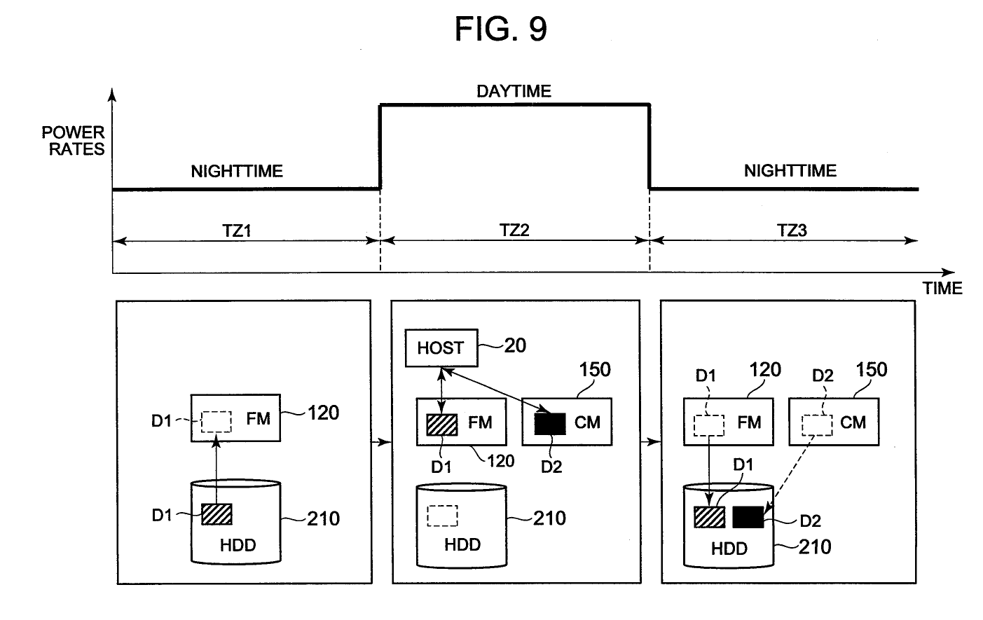

FIG. 9 is a diagram schematically showing the operation of the storage controller 10 according to this embodiment. Changes in the power rate are shown at the top of FIG. 9, and changes in data storage destinations are shown at the bottom of FIG. 9.

During the nighttime hours TZ1 of a given day, the power rate is low. Prescribed data D1 stored in a disk drive 210 is copied to the flash memory device 120 during the time period TZ1 on this night. That is, a staging process is carried out from the disk drive 210 to the flash memory device 120 during time period TZ1 when the power rate is low.

During the daytime hours TZ2 of the following day, the power rate is high. A host 20 uses the storage controller 10 during time period TZ2 of this day. There are exceptions, but for the most part, work hours are set during the day time period TZ2, and a host 20 accesses a logical volume during these work hours. As described hereinabove, at least a portion (D1) of the data to be accessed by the host 20 is copied to the flash memory device 120 in advance prior to the host 20 commencing to use the storage controller 10.

Therefore, at least a portion of an access request from the host 20 is processed using data D1 stored in the flash memory device 120. Because the flash memory device 120 consumes less power than a disk drive 210, the cost of power during logical volume usage can be reduced to the extent possible by using the flash memory device 120 to process an access request from the host 20. Furthermore, since the disk drive 210 is not utilized that much, it is set to the spin-down state.

When there is not much free space left in the flash memory device 120, write data D2 received from the host 20 can be stored in the cache memory 150. Further, when the host 20 requests a readout of data other than the data D1 copied to the flash memory device 120, the storage controller 10 operates the disk drive 210 and reads out the data requested by the host 20.

When the day time period TZ2 ends, power costs transition to the night time period TZ3 when the power rate is low. During the night time period TZ3, data D1 updated during the day time period TZ2 is copied to the disk drive 210 from the flash memory device 120. Only the difference between the data D1 inside the flash memory device 120 and the data D1 inside the disk drive 210 needs to be copied from the flash memory device 120 to the disk drive 210. The data D2 stored in the cache memory 150 is copied to the disk drive 210 during the night time period TZ3.

Thus, the storage controller 10 of this embodiment executes staging from the disk drive 210 to the flash memory device 120 during the low-power-rate time period TZ1 of prior to the commencement of work, processes access requests from the host 20 using the low-power-consumption flash memory device 120 during working hours TZ2 when the power rate is high, and executes destaging from the flash memory device 120 to the disk drive 210 during the low-power-rate time period TZ3 subsequent to the end of work. Therefore, since the disk drive 210, which consumes a lot of power, is mainly operated during the low-power-rate time periods TZ1, TZ3, the power costs of the storage controller 10 can be reduced.

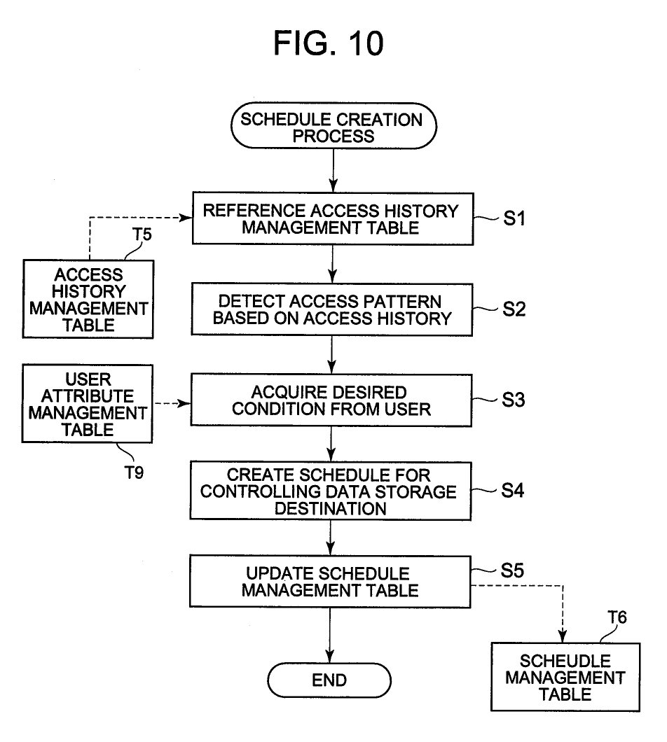

FIG. 10 is a flowchart showing a process for creating a schedule for controlling a data storage destination. Furthermore, the respective flowcharts hereinbelow show overviews of processing to the extent needed to understand and implement the present invention, and may differ from an actual computer program. A so-called person skilled in the art should be able to delete, change or rearrange the order of the steps shown in the figures.

The storage controller 10 references the access history management table T5 (S1), and detects an access pattern based on the access history (S2). The access pattern is information which classifies when and to what extent this logical volume has been accessed.

The storage controller 10 acquires a desired condition stipulated by the user (S3). The user can manually select either “cost priority” or “performance priority”. Or, the storage controller 10 can also automatically set a user desired condition based on a user attribute management table T9. The user attribute management table T9, for example, can be configured with the department, position, and duties of the user, who will utilize the logical volume.

The storage controller 10 creates a schedule by executing steps S1 through S3 (S4), and updates the schedule management table T6 (S5). Furthermore, the constitution can be such that the user can check the created schedule, and make manual revisions.

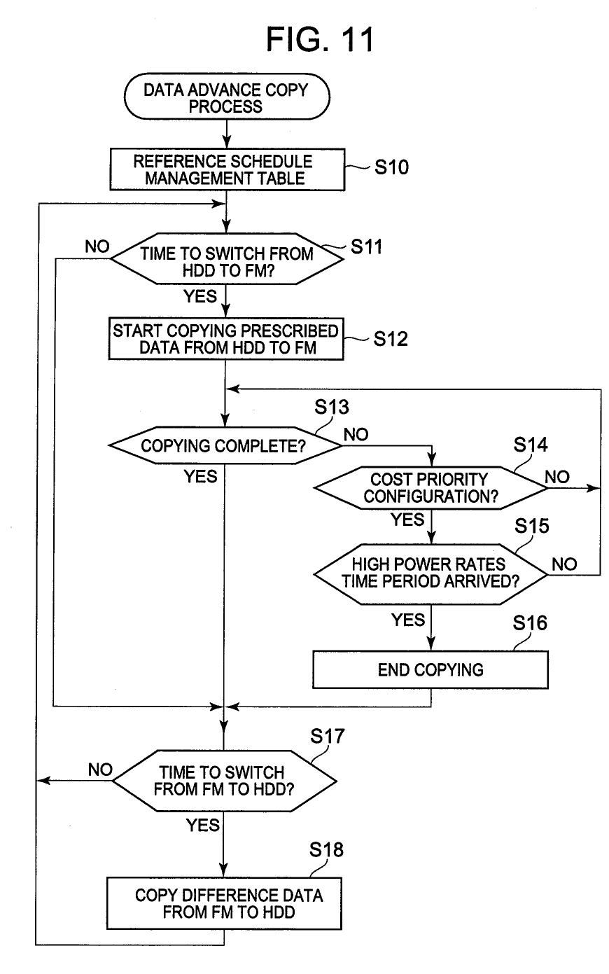

FIG. 11 is a flowchart showing a process (staging process) for copying prescribed data in advance from a disk drive 210 to the flash memory device 120.

The storage controller 10 references the schedule management table T6 (S10), and determines whether or not the period for switching the data storage destination from the disk drive 210 to the flash memory device 120 has arrived (S11).

For example, when a user is scheduled to use a logical volume starting Monday morning, a time, which takes into account the time period needed to copy the data, is selected as the switching period (that is, the schedule start time) during the low-power-rate time period of prior to the user commencing work.

When the determination is that the switching time has arrived (S11: YES), the storage controller 10 starts copying the prescribed data from the disk drive 210 to the flash memory device 120 (S12). The prescribed data can be all the data in the logical volume, or it can be a prescribed amount of data from the head of the logical volume. Or, it can be a prescribed amount of the data stored in the logical volume, for which the update time is relatively recent.

The storage controller 10 makes a determination as to whether or not copying from the disk drive 210 to the flash memory device 120 has ended (S13). When the data copy has not ended (S13: NO), the storage controller 10 determines whether or not the user desired condition is “cost priority” (S14).

When the user desired condition is cost priority (S14: YES), the storage controller 10 determines whether or not the time period when power costs are high (typically, daytime) has arrived (S15). When the high-power-rate time period has arrived (S15: YES), the storage controller 10 ends the copying of data from the disk drive 210 to the flash memory device 120 (S16). By contrast, when the user desired condition is “performance priority” (S14: NO), or when power costs have not transitioned to the high-power-rate time period (S15: NO), processing returns to S13.

When the copying of data from the disk drive 210 to the flash memory device 120 ends (S13: YES), the storage controller 10 waits for the period (that is, the destaging start time), when the data storage destination switches from the flash memory device 120 to the disk drive 210, to arrive (S17).

When the period for copying data from the flash memory device 120 to the disk drive 210 arrives (S17: YES), the storage controller 10 copies the difference between the data stored in the flash memory device 120 and the data stored in the disk drive 210 from the flash memory device 120 to the disk drive 210 (S18).

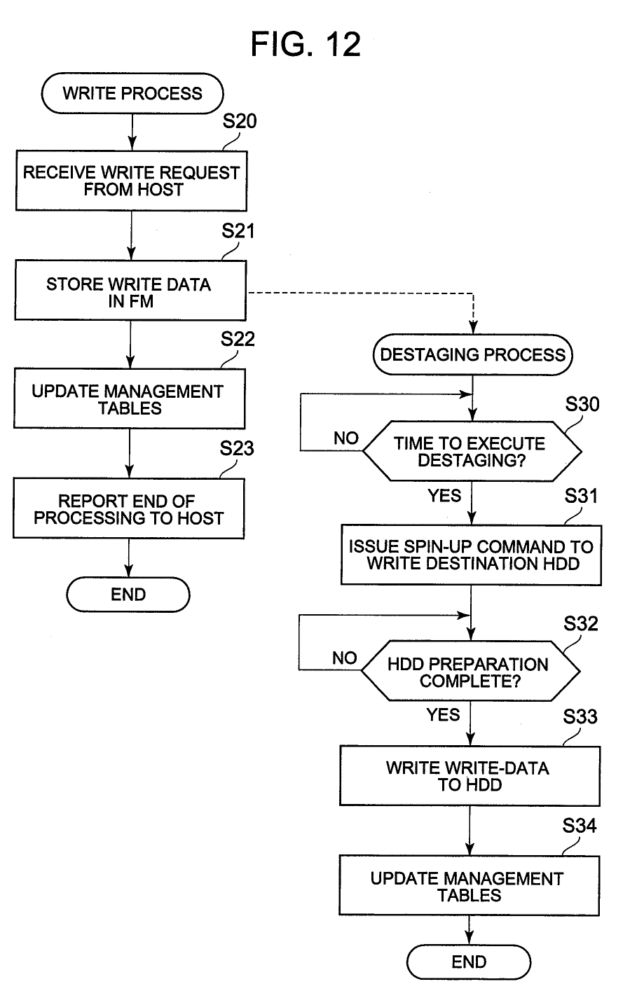

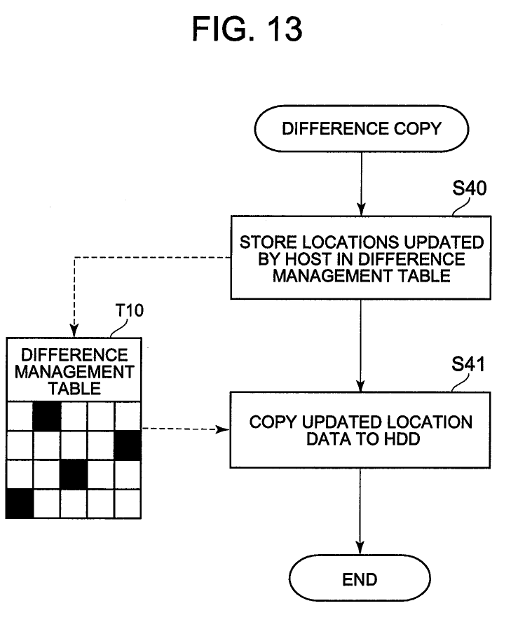

FIG. 12 is a flowchart of the processing of write data from a host 20. The storage controller 10, upon receiving a write request (S20), stores the write data received from the host 20 in the flash memory device 120 (S21). Then, the storage controller 10 updates required management tables, such as a difference management table T10 (Refer to FIG. 13) (S22), and notifies the host 20 when processing ends (S23).

Conversely, the storage controller 10 determines whether or not the period for executing destaging has arrived (S30). The destaging execution period, as described above, is selected from the night time periods when the power rate is low.

When the destaging execution period arrives (S30: YES), the storage controller 10 starts up the write-destination disk drive 210 by issuing a spin-up command to the disk drive 210 (S31), and determines whether or not write-destination disk drive 210 preparation is complete (S32).

When write-destination disk drive 210 preparation is complete (S32: YES), the storage controller 10 transfers and stores the data stored in the flash memory device 120 in this write-destination disk drive 210 (S33). The storage controller 10 updates the required management tables, such as the difference management table T10 (S34), and ends destaging.

FIG. 13 is a flowchart showing a process for carrying out a difference copy. The storage controller 10 records the location, which was updated by the host 20 (that is, the updated logical block address) in the difference management table T10 (S40). The difference management table T10 manages the location in which data is updated in prescribed units. The difference management table T10 can be constituted as a difference bitmap.

Then, the storage controller 10 copies only the data of the location updated by the host 20 to the disk drive 210 by referencing the difference management table T10 (S41). Consequently, the storage contents of the flash memory device 120 and the storage contents of the disk drive 210 can be made to coincide in a relatively short period of time.

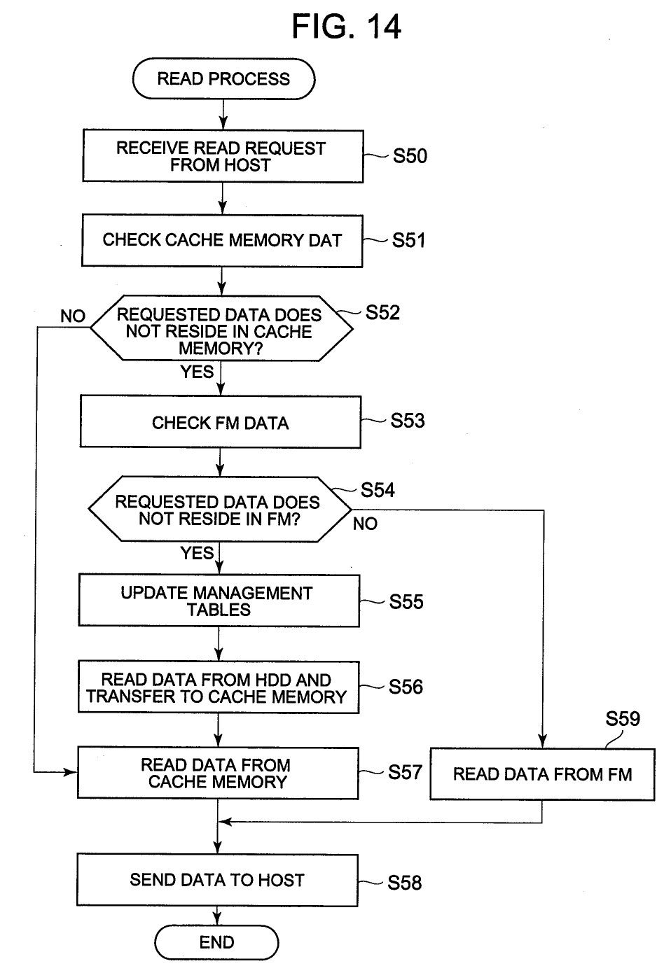

FIG. 14 is a flowchart of the processing of a read request from a host 20. The storage controller 10, upon receiving a read request issued from the host 20 (S50), confirms the data stored in the cache memory 150 (S51).

When the host 20 read-request data is not stored in the cache memory 150 (S51: YES), the storage controller 10 confirms the data stored in the flash memory device 120.

When the read-request data is not stored in the flash memory device 120 (S54: YES), the storage controller 10 updates the required management tables, such as the device status management table T3 (S55), reads out the read-target data from the disk drive 210, and transfers this data to the cache memory 150 (S56). The storage controller 10 reads the read-target data from the cache memory 150 (S57), and sends this data to the host 20 (S58).

When the read-target data is stored in the cache memory 150 (S52: YES), the storage controller 10 sends the data stored in the cache memory 150 to the host 20 (S57, S58).

When the read-target data is stored in the flash memory device 120 (S54: NO), the storage controller 10 reads the data from the flash memory device 120 (S59), and sends this data to the host 20 (S58).

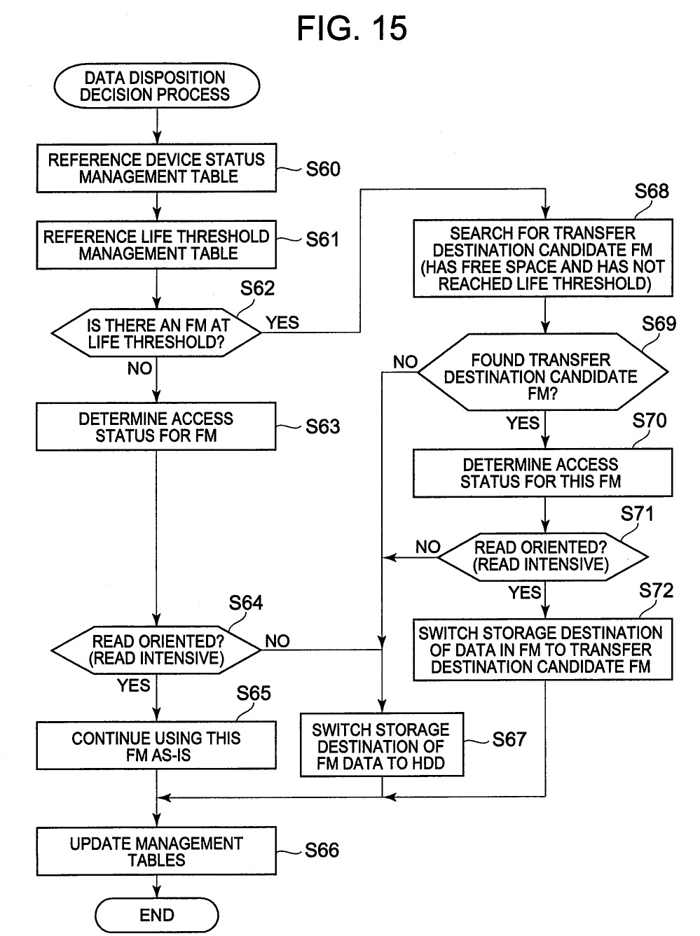

FIG. 15 is a flowchart showing a process for deciding a data disposition destination. This process is executed for automatically configuring the “disposition setting flags” inside the schedule management table T6.

That is, in the following process, the storage controller 10 determines the propriety of staging from the disk drive 210 to the flash memory device 120 based on the reliability (remaining life) of the flash memory device 120 and the data access pattern, and registers the results of this decision in the schedule management table T6.

The storage controller 10 references the device status management table T3 (S60), and also references the life threshold management table T4 (S61). The storage controller 10 determines whether or not there exists a flash memory device 120, which has reached the life threshold of any one of the life prediction parameters (S62).

When none of the flash memory device 120 has reached the life threshold (S62: NO), the storage controller 10 determines the access status for a flash memory device 120 (S63). The storage controller 10 determines whether or not access to the flash memory device 120 is read-access intensive (S64). The storage controller 10, for example, can determine whether or not read accesses are more prevalent based on the percentage of total number of write accesses to total number of read accesses for this flash memory device 120. For example, when read accesses exceed write accesses by n-fold (n is a natural number), a determination can be made that the flash memory device is used mainly for read access.

When the flash memory device is read access intensive (S64: YES), the storage controller 10 decides to continue using this flash memory device 120 as-is (S65), and, if necessary, updates the schedule management table T6 (S66). However, when the decision is to continue using the flash memory device 120 (S65), it is not necessary to update the schedule management table T6.

By contrast, when access to the flash memory device 120 is not read access intensive, and write accesses are relatively numerous (S64: NO), the storage controller 10 changes the storage location of data stored in this flash memory device 120 to a disk drive 210 (S67). That is, since more numerous write accesses reduce the life of the flash memory device 120, the storage controller 10 establishes the data storage location in the disk drive 210 beforehand (S67). In this case, the storage controller 10 sets the device number of the disk drive 210 in the disposition-setting flag for this data (S66).

When any of a flash memory device's 120 life prediction parameters has reached the life threshold (S62: YES), the storage controller 10 searches for another flash memory device 120 for switching the data storage destination (S68). That is, the storage controller 10 detects a flash memory device 120, which has sufficient free space and life remaining to become a data migration destination candidate (S68).

When a migration destination candidate flash memory device 120 is detected (S69: YES), the storage controller 10 determines the access status of this migration destination candidate flash memory device 120 (S70), and determines whether or not accesses to this migration destination candidate flash memory device 120 are read access intensive (S71).

When accesses to the migration destination candidate flash memory device 120 are read access intensive (S71: YES), the storage controller 10 selects this migration destination candidate flash memory device 120 as the data storage destination in place of the low-life flash memory device 120 (S72). In this case, the storage controller 10 registers the device number of the flash memory device 120 selected as the new storage destination in the schedule management table T6 (S68).

By contrast, when not even one migration destination candidate flash memory device 120 can be detected (S69: NO), or when the accesses to a migration destination candidate flash memory device 120 are not read access intensive (S71: NO), the storage controller 10 changes the data storage destination to a disk drive 210 (S67).

Comprising the constitution described hereinabove, this embodiment exhibits the following effects. This embodiment controls a data storage destination by taking into account not only the difference in power consumption between a flash memory device 120 and a disk drive 210, but also differences resulting from power rate time periods.

Therefore, prescribed data can be copied to a flash memory device 120 by operating a disk drive 210, which consumes a lot of power, during the night when the power rate is low. An access request from a host 20 can be processed using a flash memory device 120, which consumes little power, during the day when the power rate is high. Therefore, it is possible to reduce the power consumption of the storage controller 10.

In this embodiment, since the constitution is such that write data received from a host 20 is stored directly in the flash memory device 120 without passing through the cache memory 150, it is possible to reduce cache memory 150 usage, and it is also possible to shorten the time required to store write data.

### Second Embodiment

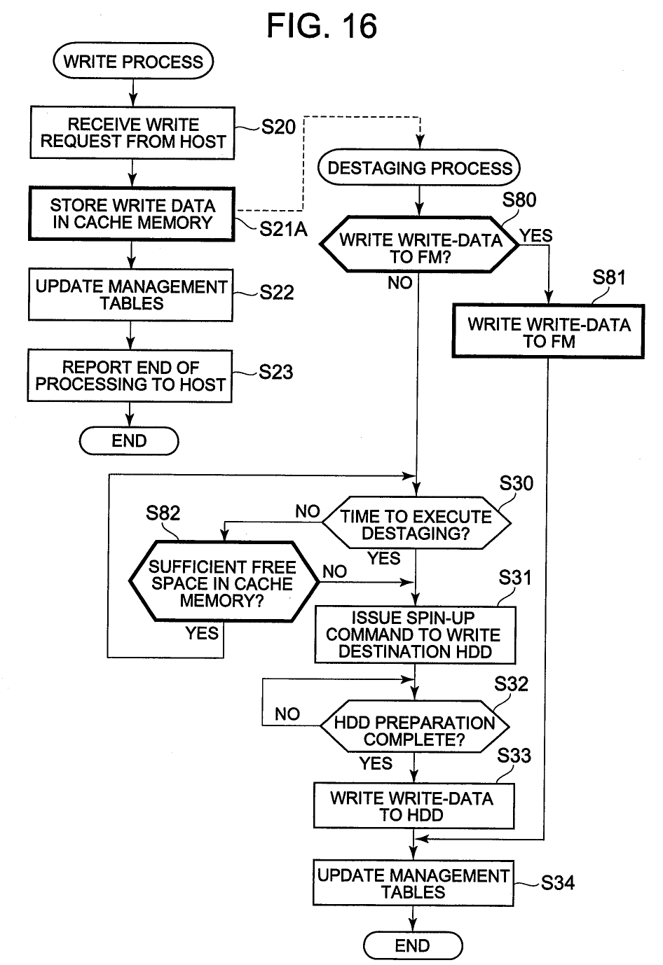

A second embodiment will be explained based on FIG. 16. The following embodiments, to include this embodiment, correspond to variations of the first embodiment. In this embodiment, write data received from a host 20 is stored in the cache memory 150, after which this write data is stored in either a flash memory device 120 or a disk drive 210.

FIG. 16 is a flowchart of a write process executed by the storage controller 10 of this embodiment. This flowchart comprises numerous steps in common with the flowchart shown in FIG. 12. Accordingly, explanations of common steps will be omitted, and the explanation will focus on steps that are characteristic to this flowchart.

Upon receiving a write request from a host 20 (S20), the storage controller 10 first stores this write data in the cache memory 150 (S21A), and next, updates management tables that need to be updated (S22) and reports to the host 20 that processing has ended (S23).

The storage controller 10 determines whether or not the write data stored in the cache memory 150 will be written to a flash memory device 120 (S80). For example, when a flash memory device 120 is specified as the storage destination for this write data, a decision is made to write the write data to the flash memory device 120.

When it is decided that the write data will be written to a flash memory device 120 (S80: YES), the storage controller 10 transfers the write data from the cache memory 150 to the flash memory device 120, and stores the write data in the flash memory device 120 (S81).

When it is decided that the write data will be written to a disk drive 210 instead of a flash memory device 120 (S80: NO), the storage controller 10 waits for the arrival of the time period during which destaging to a disk drive 210 will be executed (S30).

When the time during which destaging to the disk drive 210 can be executed arrives (S30: YES), the storage controller 10 issues a spin-up command to the write-destination disk drive 210 (S31).

Further, while waiting for the disk drive 210 destaging execution time (S30: NO), the storage controller 10 checks whether or not sufficient free space exists in the cache memory 150 (S82). When the free space in the cache memory 150 has dropped below a preset value (S82: NO), the storage controller 10 issues a spin-up command to the write-destination disk drive 210 (S31).

The storage controller 10, upon completing preparations for the write-destination disk drive 210 (S32: YES), writes the write data to this disk drive 210 (S33), and updates management tables that need to be updated (S34). Being constituted like this, this embodiment also exhibits the same effects as the above-mentioned first embodiment.

### Third Embodiment

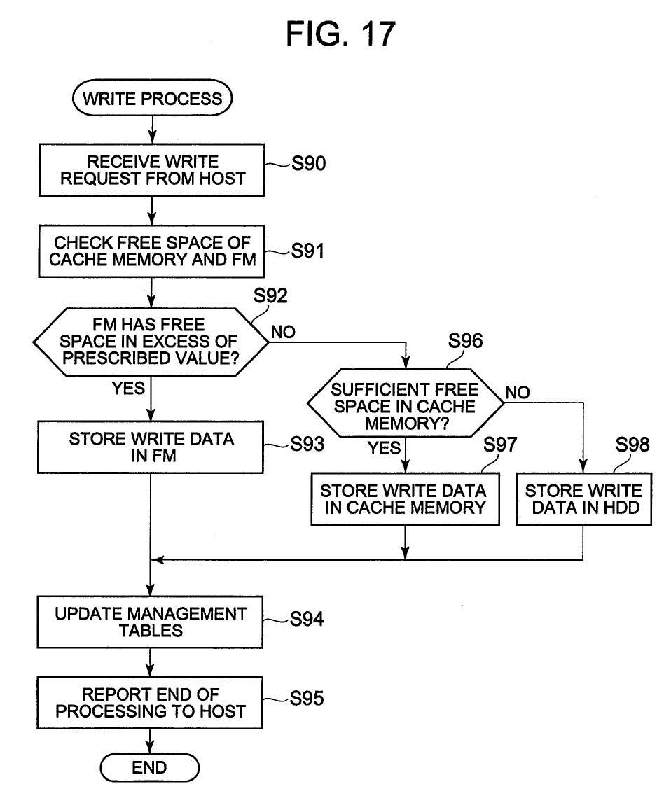

A third embodiment will be explained based on FIG. 17. In this embodiment, a flash memory device 120 is used like a second cache memory. FIG. 17 is a flowchart showing a write process executed by the storage controller 10 of this embodiment.

The storage controller 10, upon receiving write data from a host 20 (S90), respectively checks the free space in the cache memory 150 and the flash memory device 120 (S91), and determines whether or not the flash memory device 120 has free space of not less than a prescribed value (S92).

When the flash memory device 120 has free space of not less than a prescribed value (S92: YES), the storage controller 10 stores the write data in the flash memory device 120 (S93), and updates management tables that need updated (S94). Finally, the storage controller 10 reports to the host 20 that processing has ended (S95).

By contrast, when the flash memory device 120 does not have free space of not less than the prescribed value (S92: NO), the storage controller 10 determines whether or not the cache memory 150 has free space in excess of a prescribed value (S96). When the cache memory 150 has free space of not less than the prescribe value (S96: YES), the storage controller 10 stores the write data in the cache memory 150 (S97).

When the cache memory 150 does not have free space of not less than the prescribe value (S96: NO), the storage controller 10 stores the write data in a disk drive 210. Being constituted like this, this embodiment also exhibits the same effects as the above-mentioned first embodiment.

### Fourth Embodiment

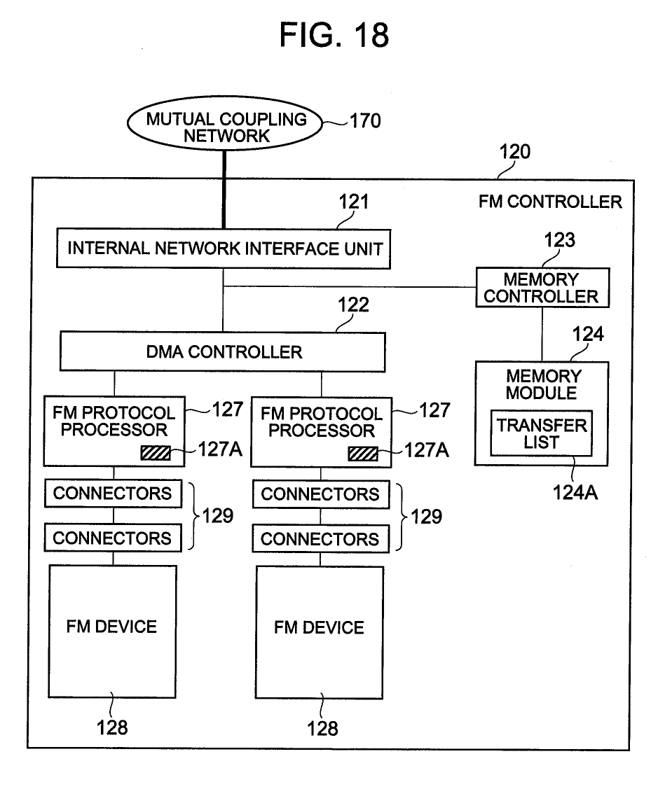

A fourth embodiment will be explained based on FIG. 18. In this embodiment, a variation of the FM controller 120 will be explained. FIG. 18 is a schematic diagram showing the constitution of an FM controller 120 according to this embodiment. The FM controller 120 of this embodiment comprises FM protocol processors 127 instead of the memory controllers 125 of the first embodiment. Further, the FM controller 120 of this embodiment has flash memory devices 128 instead of flash memories 126.

A FM protocol processor 127 is for carrying out data communications with a flash memory device 128. Furthermore, a memory 127A built into a FM protocol processor 127 is capable of recording historical information related to accesses to a flash memory device 128.

A FM protocol processor 127 is connected to a flash memory device 128 by way of connectors 129. Therefore, the flash memory devices 128 are detachably attached to the FM controller 120.

The above-mentioned first embodiment shows a constitution, which provides flash memories 126 on a circuit board of the FM controller 120. Therefore, in the above-mentioned embodiments, augmenting the capacity of a flash memory and replacing a failed flash memory are troublesome tasks. By contrast, in this embodiment, since the FM protocol processors 127 and flash memory devices 128 are detachably attached via connectors 129, an existing flash memory device 128 can easily be replaced with a new flash memory device 128 or a large-capacity flash memory device 128.

### Fifth Embodiment

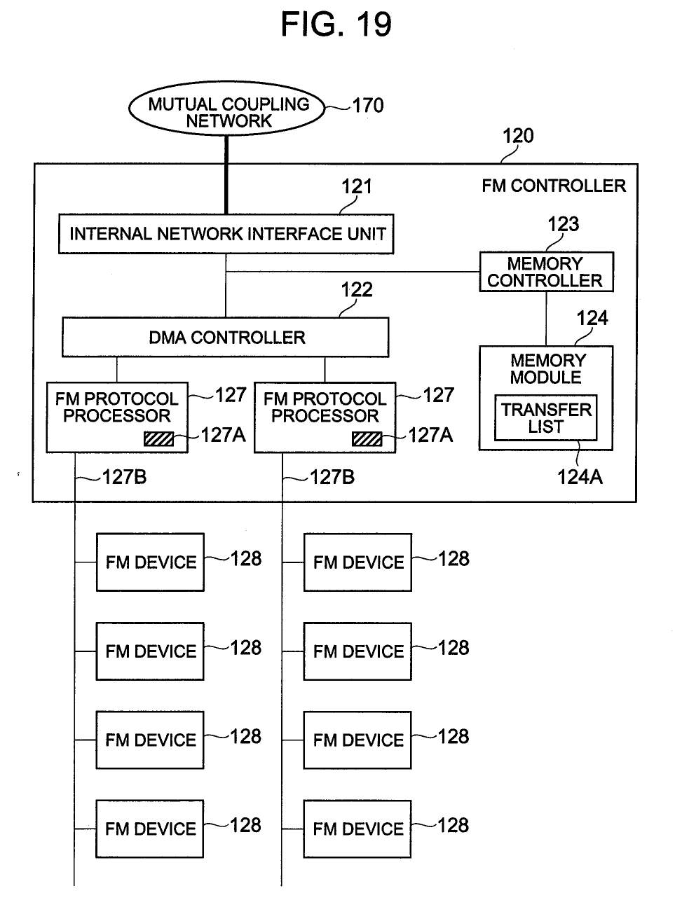

A fifth embodiment will be explained based on FIG. 19. In this embodiment, another variation of the FM controller 120 will be explained. In the FM controller 120 of this embodiment, a plurality of flash memory devices 128 are each respectively connected to the FM protocol processors 127 via communication channels 127B. Consequently, in this embodiment, more numerous flash memory devices 128 can be put to use.

### Sixth Embodiment

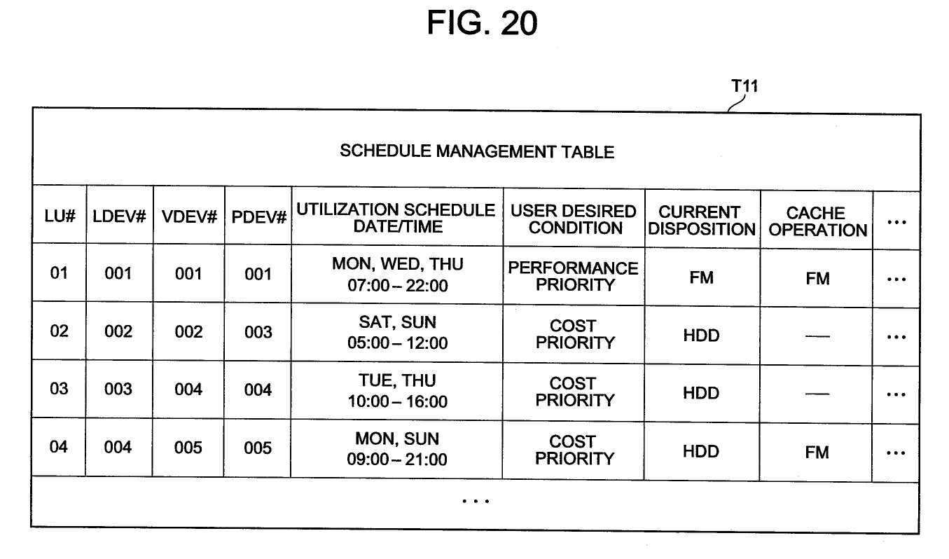

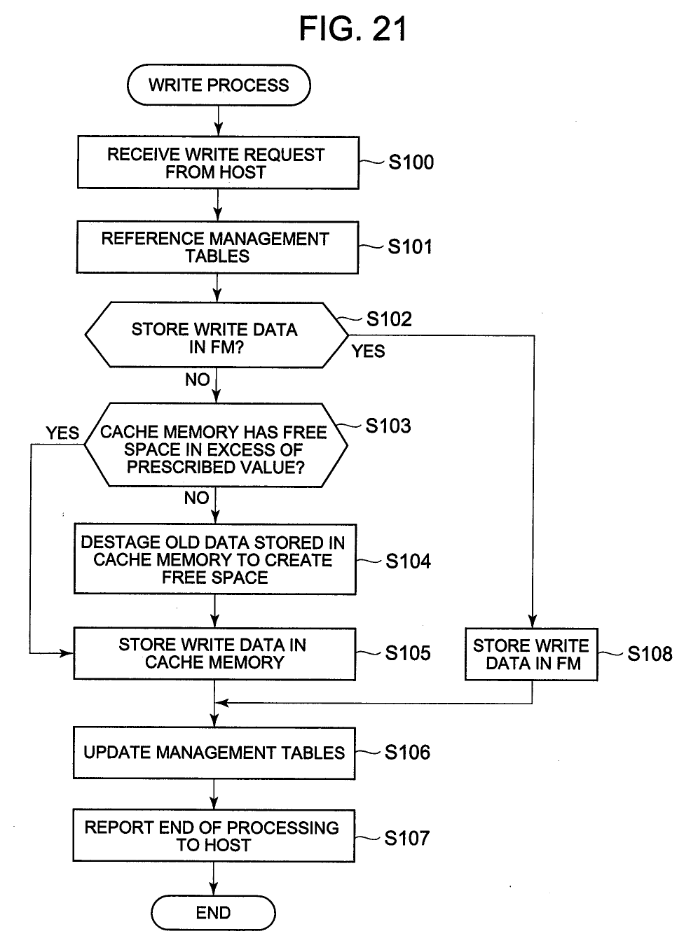

A sixth embodiment will be explained based on FIGS. 20 and 21. In this embodiment, write data sent from a host 20 is stored in a flash memory device 120 only when so specified in advance by a user, and otherwise, write data is stored in the cache memory 150.

FIG. 20 is a schematic diagram showing an example of a schedule management table T11 used in this embodiment. This management table T11, for example, correspondently manages an LU#, LDEV#, VDEV #, PDEV#, utilization schedule date/time, user desired condition, current disposition, and cache operation.

“Cache operation” is information for specifying whether or not a flash memory device 120 will be used as a storage destination for received write data. Cache operation can be specified in advance by a user. Furthermore, instead of the user manually configuring the cache operation, the constitution can be such that the write data storage destination is automatically set to the flash memory device 120 when data has been copied to the flash memory device 120 (that is, upon completion of staging).

FIG. 21 is a flowchart showing a write process according to this embodiment. The storage controller 10, upon receiving write data from a host 20 (S100), references the management table T11 shown in FIG. 20 (S101), and determines whether or not a flash memory device 120 will be used as the initial storage destination for the write data (S102).

When it is determined that a flash memory device 120 will not be used as the write data storage destination device (S102: NO), the storage controller 10 determines if free space of not less than a prescribed value exists in the cache memory 150 (S103). That is, the storage controller 10 determines whether or not there is sufficient free space to store the write data.

When the cache memory 150 does not have free space of not less than the prescribed value (S103: NO), the storage controller 10 creates free space of not less than the prescribed value by deleting old data from the data stored in the cache memory 150 (S104). For example, the storage controller 10 creates free space of the amount required by deleting, in order from the oldest data, data for which destaging has ended.

A write command issued from a host 20 comprises the size of the write data to be sent henceforth. The storage controller 10, upon receiving the write command, determines whether or not preparations have been made for receiving the write data, and when it is determined that write data receiving preparations have been made, the responds to the host 20.

Then, the storage controller 10 stores the write data received from the host 20 in the cache memory 150 (S105). The storage controller 10 updates the management tables that need to be updated (S106), and reports to the host 20 to the effect that write command processing has ended (S107).

When the cache memory 150 has free space of not less than the prescribed value (S103: YES), processing skips S104, and proceeds to S105. When it is determined that a flash memory device 120 will be used as the write data storage destination in S102 (S102: YES), the storage controller 10 stores the write data received from the host 20 in the flash memory device 120 (S108). Being constituted like this, this embodiment also exhibits the same effects as the above-mentioned first embodiment.

### Seventh Embodiment

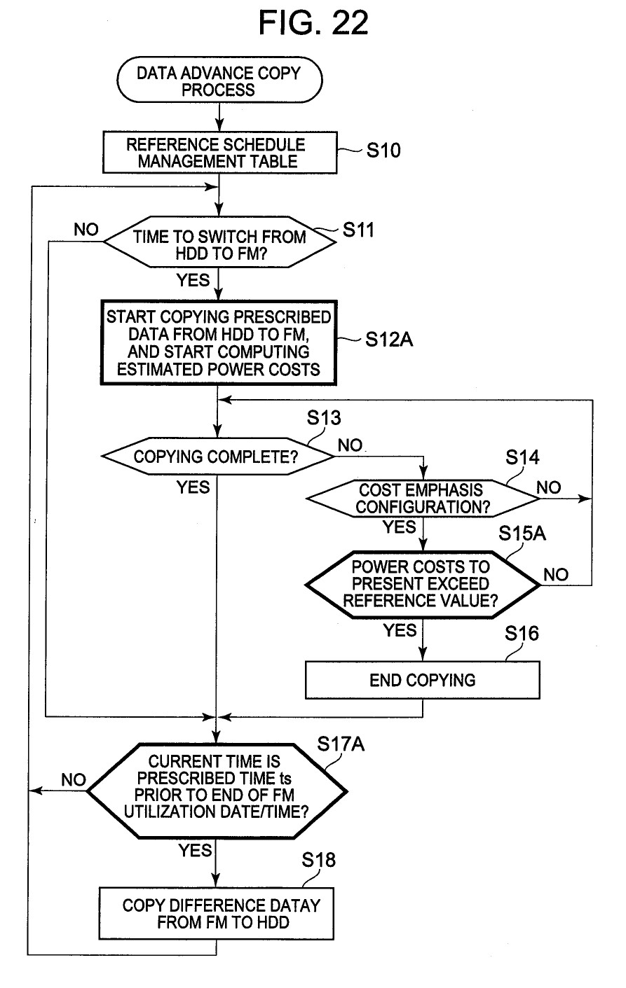

A seventh embodiment will be explained based on FIG. 22. In this embodiment, a different example from that of the first embodiment will be explained as the timing for switching the usage of the flash memory device 120 and the disk drive 210.

FIG. 22 is a flowchart showing a data advance copy process executed by a storage controller 10 according to this embodiment. The flowchart shown in FIG. 22 comprises steps in common with the flowchart shown in FIG. 11. Accordingly, a duplicate explanation will be omitted, and the explanation will focus on steps characteristic to this embodiment.

When it is determined that the time for switching from the disk drive 210 to the flash memory device 120 has arrived (S11: YES), the storage controller 10 starts copying data from the disk drive 210 to the flash memory device 120, and commences computing the estimated cost of the power being consumed by the storage controller 10 (S12A).

When a cost priority configuration is set (S14: YES), the storage controller 10 determines whether or not the estimated power cost up to the present exceeds a preset reference value (S15A). The reference value can be set in advance by the user. The reference value, for example, can be set as an amount showing the upper limit of allowable power costs for the user. When the estimated power cost amount exceeds the reference value (S15A: YES), the storage controller 10 ends the data copy from the disk drive 210 to the flash memory device 120 (S16).

Next, the storage controller 10 determines whether or not the current time is a prescribed time ts prior to the end time of the flash memory device 120 utilization schedule date/time registered in the management table (S17A). For example, if the utilization schedule date/time is set to “9:00 to 18:00 on weekdays”, and “1 hour” is set as the prescribed time ts, the storage controller 10 determines whether or not the current time is 17:00 (18−1=17).

When the determination in S17A is YES, the storage controller 10 starts a difference copy from the flash memory device 120 to the disk drive 210 (S18). The prescribed time ts can be set manually by the user, and it can also be set automatically on the basis of a preset prescribed aspect. For example, the size of an update, which occurs while using the flash memory device 120, can be cited as a prescribed aspect. That is, the prescribed time ts can be set corresponding to the amount of difference data to be copied from the flash memory device 120 to the disk drive 210. For example, the greater the amount of difference data, the longer the prescribed time ts can be made.

Being constituted like this, this embodiment also exhibits the same effects as the above-mentioned first embodiment. Furthermore, in this embodiment, since a data copy from the disk drive 210 to the flash memory device 120 is ended when the estimated power cost exceeds the reference value, it is possible to curb the occurrence of power costs that exceed the user's budget. Therefore, the user can properly manage the TCO of the storage controller 10, thereby enhancing usability.

Furthermore, in this embodiment, since the start time of a difference copy from the flash memory device 120 to the disk drive 210 is associatively set to the utilization schedule date/time of the flash memory device 120, it is possible to start a difference copy in accordance with the time at which flash memory device 120 usage ends. Furthermore, the constitution can also be such that the storage controller 10 starts a difference copy from the flash memory device 120 to the disk drive 210 at the point in time when the prescribed time ts is superseded and the end time of the utilization schedule date/time arrives.

Furthermore, the present invention is not limited to the embodiments described hereinabove. A person skilled in the art can make various additions and changes without departing from the scope of the present invention. For example, the constitution can be such that a plurality of types of flash memory devices with different technical properties and performance, like a NAND-type flash memory device and a NOR-type flash memory device, are used together.

What is claimed is:

1. A storage controller, which stores data to be used by a higher-level device, comprising:
a first storage device, which comprises a nonvolatile, rewritable storage medium, and for which power consumption is relatively low;
a second storage device, which comprises a nonvolatile, rewritable storage medium, and for which power consumption is relatively high;
a schedule manager for managing a schedule for controlling a storage destination of prescribed data based on power costs; and
a controller for respectively controlling operation of said first storage device and said second storage device, and for switching the storage destination of said prescribed data between said first storage device and said second storage device on the basis of said schedule.

2. The storage controller according to claim 1, wherein said controller uses said first storage device to process an access request from said higher-level device.

3. The storage controller according to claim 1, wherein said controller controls the storage destination of said prescribed data based on said schedule such that said storage destination becomes said first storage device during a time period when said power costs are relatively high, and becomes said second storage device during a time period when said power costs are relatively low.

4. The storage controller according to claim 1, wherein information showing a first period during which said higher-level device accesses said prescribed data is also recorded in said schedule.

5. The storage controller according to claim 4, further comprising an access status manager for detecting and managing a state in which said higher-level device accesses said prescribed data, wherein
said access status manager is used to create said schedule.

6. The storage controller according to claim 4, wherein a condition preset by a user, who utilizes said prescribed data, is also recorded in said schedule.

7. The storage controller according to claim 4, wherein said controller copies in advance at least a portion of said prescribed data from said second storage device to said first storage device prior to arrival of said first period, and copies a difference between contents of said first storage device and contents of said second storage device from said first storage device to said second storage device following the end of said first period.

8. The storage controller according to claim 7, wherein said controller stores write data received from said higher-level device in said first storage device when a free space of said first storage device is not less than a prescribed value, and stores said write data in said second storage device when the free space of said first storage device is less than said prescribed value.

9. The storage controller according to claim 7, further comprising a cache memory,
wherein said controller:
(1) stores write data received from said higher-level device in said first storage device when a free space of said first storage device is not less than a prescribed value;
(2) stores said write data in said cache memory when the free space of said first storage device is less than said prescribed value, and a free space of said cache memory is not less than another prescribed value; and
(3) stores said write data in said second storage device when the free space of said first storage device is less than said prescribed value, and the free space of said cache memory is less than said other prescribed value.

10. The storage controller according to claim 3, wherein
information showing a first period in which said higher-level device accesses said prescribed data, and one condition of either a first condition or a second condition set by a user, who utilizes said prescribed data, are respectively set in said schedule, and
said controller (1) commences copying said prescribed data from said second storage device to said first storage device prior to arrival of said first period, (1a) when said first condition has been set, ends said copying upon transitioning from the time period when said cost of power is relatively low to the time period when said cost of power is relatively high, and (1b) when said second condition is set, copies all of said prescribed data from said second storage device to said first storage device even after transitioning to the time period when said cost of power is relatively high.

11. The storage controller according to claim 1, wherein said controller transitions said second storage device to a power saving mode when the storage destination of said prescribed data is changed from said second storage device to said first storage device.

12. The storage controller according to claim 1, wherein said controller predicts a life of said first storage device based on a utilization status of said first storage device, and when the predicted life reaches a prescribed threshold, changes said prescribed data storage destination to either said second storage device, or a different first storage device.

13. The stoppage controller according to claim 1, wherein said controller predicts a life of said first storage device based on a utilization status of said first storage device, and when the predicted life reaches a prescribed threshold and a percentage of read requests related to said first storage device is less than a preset determination threshold, changes said prescribed data storage destination to either said second storage device, or a different first storage device.

14. The storage controller according to claim 1, wherein said controller predicts a life of said first storage device based on a utilization status of said first storage device, and (1) when the predicted life reaches a prescribed threshold, (1a) changes said prescribed data storage destination to said second storage device when a percentage of read requests related to said first storage device is less than the preset determination threshold, (1b) changes said prescribed data storage destination to a different first storage device when said percentage of read requests related to said first storage device is not less than said determination threshold, and also (2) changes said prescribed data storage destination to said second storage device when said percentage of read requests related to said first storage device is less than said determination threshold even though said predicted life has not reached said prescribed threshold.

15. The storage controller according to claim 1, wherein said first storage device is a flash memory device, and said second storage device is a hard disk device.

16. A method for controlling a storage controller, which stores data to be used by a higher-level device,
said storage controller being able to respectively make use of a first storage device for which power consumption is relatively low, and a second storage device for which power consumption is relatively high, and
said method comprising the steps of:
commencing to copy prescribed data from said second storage device to said first storage device during a second period prior to arrival of a first period in which said higher-level device accesses said prescribed data;
using said first storage device to process an access request from said higher-level device;
detecting a difference, which occurs between said first storage device and said second storage device resulting from said access request; and
copying said difference from said first storage device to said second storage device during a different second period subsequent to the end of said first period,
said first period being set at a time period when power costs are relatively high, and said second period being set at a time period when power costs are relatively low.
